(19) United States
(12) Patent Application Publication
(10) Pub. No.: US 2012/0291816 A1
(43) Pub. Date: Nov. 22, 2012

(54) DISHWASHER USING OZONE

(75) Inventors: Caroline Heiligenmann, Boeblingen (DE); Helmut Jerg, Giengen (DE)

(73) Assignee: BSH BOSCH UND SIEMENS HAUSGERATE GMBH, Munich (DE)

(21) Appl. No.: 13/563,790

(22) Filed: Aug. 1, 2012

Related U.S. Application Data
(63) Continuation of application No. 10/583,502, filed on Feb. 27, 2007, now abandoned.

(30) Foreign Application Priority Data
Dec. 23, 2003 (DE) 10360906.7

(51) Int. Cl. A47L 15/44; B08B 3/04; B08B 3/12; B08B 5/00

(52) U.S. Cl. 134/25.2; 134/94.1; 134/102.1

(57) ABSTRACT

A dishwasher is provided that allows oxygenating gases, especially ozone, to be effectively used at least for cleaning and disinfecting. An oxygenating gas is added to the rinsing liquor or the crude water and/or the washing container for use in a partial program cycle having a cleaning effect, e.g. the “cleaning” cycle, in order to be able to use the gas at least for cleaning and disinfecting.

### CROSS-REFERENCE TO RELATED APPLICATIONS

This application is a continuation, under 35 U.S.C. §120, of U.S. application Ser. No. 10/583,502, filed Feb. 27, 2007, which is a U.S. national stage application under 35 U.S.C. §371 of PCT/EP2004/053430, filed Dec. 13, 2004, which designated the United States; this application also claims the priority, under 35 U.S.C. §119, to German Application No. 103 60 906.7, filed Dec. 23, 2003.

### BACKGROUND OF THE INVENTION

The invention relates to a dishwasher comprising a washing container, devices for applying rinsing liquor to the items to be washed in the washing container and at least one wash program comprising partial program steps e.g. “pre-wash”, “clean”, “intermediate rinse” and “clear rinse” and a method for using a gas having an oxygenating effect in a dishwashers with at least one wash program steps comprising partial program steps e.g. “pre-wash”, “clean”, “intermediate rinse” and “clear rinse”.

Ozone is a strong oxidising agent. It is generally known that ozone has properties such as deodorising, sterilising and oxidation of organic substances. Ozone as a strong oxidising agent bleaches many organic dyes and destroys bacteria. It is used as a disinfectant in breweries and cold stores and for cleaning drinking water where ozone destroys flavouring substances, odorous substances and dyes as well as bacteria and viruses from unclean water by oxidation.

Known from U.S. Pat. No. 6,363,951 B1 is an ozonization system for washing and cleaning objects. The system includes a container, e.g. a kitchen sink, an ozonization unit and a diffuser. In the container, food or crockery are preferably cleaned using ozone. Air is sucked in from the environment and passed through the ozonization unit. The oxygen contained in the air is converted into ozone and fed into the sink. Two possibilities are provided for this. Either the ozone is passed via a cylindrical diffusion portion at the end of a hose into the water in the sink. The cylindrical diffusion portion has openings through which the ozone passes into the water. This consists of an ozone-resistant porous material such as plastic. In a second embodiment a diffusion plate is provided at the bottom of the container. The diffusion plate is made of ozone-resistant porous material, the size of the openings being such that only ozone enters the water and water conversely does not pass through the openings. Disadvantageously, the ozonization system can only be used for manual cleaning processes and the ozone can only be used for cleaning purposes.

US 2003/0080068 A1 discloses a device and a method for treating air and water in household appliances, e.g. refrigerators, washing machines and laundry driers, and dishwashers, for disinfection. Ultraviolet radiation is used to produce ozone. The ultraviolet radiation is passed into a container with air and water. The water container is transparent to ultraviolet radiation and preferably tubular. The disinfected water is used in the household appliance and the air mixed with ozone is used in the household appliance to disinfect the interior of the household appliances, in refrigerators, for example at a time during which the refrigerator is not used. Disadvantageously, the ozone produced by ultraviolet rays can only effectively be used for disinfection as a result of the devices which are present.

DE 32 32 057 A1 discloses a cleaning machine such as a washing machine or dishwasher comprising a storage container for the rinsing liquor and a program controller which controls the cleaning process wherein an ozone generator generates ozone to make the items to be cleaned largely bacteria-free. In the dishwasher comprising a washing chamber as the storage container for the crockery, at least one spray arm for the cleaning agent is disposed in the washing chamber. The rinsing liquor is circulated using a circulating pump and a circulating pipe and is distributed onto the items to be cleaned, e.g. plates, using the spray arm by means of nozzles. An ozone generator takes up air from the washing chamber via an air removal pipe, this air having been previously dried by an air drier. The air containing ozone produced in the ozone generator is passed to a branch on the circulating pipe to enrich the rinsing liquor in the circulating pipe with ozone. The branch is constructed as a venturi nozzle, for example. The ozone is only added in the final rinsing processes. A disadvantage here is that since the ozone is simply added in the circulating pipe only during the final rinsing processes, the ozone can only be used for disinfection.

### BRIEF SUMMARY OF THE INVENTION

It is thus the object of the invention to provide a dishwasher and a relevant method which allows gases having an oxidising effect, especially ozone, to be used effectively at least for cleaning and for disinfection.

This object is solved by a dishwasher and method according to the invention characterised by the present claims.

The dishwasher according to the invention comprises a washing container, devices for applying rinsing liquor to the items to be washed in the washing container, and at least one wash program comprising partial program steps e.g. “pre-wash”, “clean”, “intermediate rinse” and “clear rinse”, wherein a gas having an oxidising effect is added to the rinsing liquor or the raw water and/or into the interior of the washing container for use in a partial program step having a cleaning effect, e.g. “clean” so that the gas can at least be used for cleaning and disinfection.

In an advantageous embodiment, the gas having an oxidising effect can be applied to the items to be washed in cooperation with mist in the washing container. As a result, the gas having an oxidising effect which is dissolved in the mist droplets, can also act inside the contaminants of the items to be washed because the diameter of the mist droplets is smaller than diameters of the contaminant pores.

The mist can appropriately be produced from rinsing liquor or raw water by a nebulising device, e.g. an ultrasonic nebuliser or a nebulising nozzle.

In a further embodiment, the gas having an oxidising effect is already added to the rinsing liquor or the raw water which is supplied to the nebulising device. As a result, mist containing dissolved gas having an oxidising effect can advantageously be produced directly by the nebulising device.

Advantageously, no gas having an oxidising effect is added to the rinsing liquor or the raw water which is supplied to the nebulising device and the gas having an oxidising effect is added directly to the interior of the washing container. This makes it possible to add gas having an oxidising effect directly into the interior of the washing container where the gas having an oxidising effect is only dissolved in the mist droplets inside the washing container.

In a further embodiment, the gas having an oxidising effect is added to the rinsing liquor for solution and reaction, using a porous membrane in the rinsing liquor, preferably at the bottom of the washing container. The use of a porous membrane allows the gas having an oxidising effect to be distributed very finely in the rinsing liquor so that the solubility and the cleaning capacity is improved.

The gas having an oxidising effect is appropriately added to the rinsing liquor for solution and reaction using a water jet diffuser for fine distribution of the gas. The use of a diffuser allows the gas having an oxidising effect to be distributed very finely in the rinsing liquor so that the solubility and the cleaning capacity is improved.

The water jet pump is preferably disposed in the raw water pipe or in the circulating pipe for acting upon the devices for applying rinsing liquor to the items to be washed, wherein preferably only a portion of the raw water or the rinsing liquor is passed to a branch by the water jet pump. As a result, gas having an oxidising effect can be added to the entire raw water or rinsing liquor during circulation.

Appropriately, gas having an oxidising effect is added to the rinsing liquor or the raw water in the rinsing liquor reservoir and/or the heat exchanger for disinfection, to prevent growth of bacteria in the rinsing liquor reservoir and/or heat exchanger. This allows rinsing liquor reservoirs and heat exchangers to be used hygienically and safely even with fairly long storage times.

In an advantageous embodiment, the gas having an oxidising effect is ozone which is produced in an ozone generator. Ozone is the strongest gaseous oxidising agent so that a particularly strong cleaning and disinfectant effect is obtained therefrom and furthermore, it can be produced very simply in an ozone generator in situ in a dishwasher.

In a method according to the invention for using a gas having an oxidising effect in a dishwasher having at least one wash program comprising partial program steps e.g. “pre-wash”, “clean”, “intermediate rinse” and “clear rinse”, a gas having an oxidising effect is added to the rinsing liquor or the raw water and/or into the interior of the washing container for use for a partial program step having a cleaning effect, e.g. “clean” so that the gas can at least be used for cleaning and disinfection.

In an advantageous embodiment, the gas having an oxidising effect can be applied to the items to be washed in cooperation with mist in the washing container. As a result, the gas having an oxidising effect which is dissolved in the mist droplets, can also act inside the contaminants of the items to be washed because the diameter of the mist droplets is smaller than diameters of the contaminant pores.

The mist is appropriately produced from rinsing liquor or raw water by a nebulising device, e.g. an ultrasonic nebuliser or a nebulising nozzle.

Advantageously, the gas having an oxidising effect is already added to the rinsing liquor or the raw water which is supplied to the nebulising device. As a result, mist containing dissolved gas having an oxidising effect can advantageously be produced directly by the nebulising device.

In an advantageous embodiment, no gas having an oxidising effect is added to the rinsing liquor or the raw water which is supplied to the nebulising device and the gas having an oxidising effect is added directly to the interior of the washing container. This makes it possible to add gas having an oxidising effect directly into the interior of the washing container where the gas having an oxidising effect is only dissolved in the mist droplets inside the washing container.

Appropriately, the gas having an oxidising effect is added to the rinsing liquor for solution and reaction, using a porous membrane, preferably at the bottom of the washing container. The use of a porous membrane allows the gas having an oxidising effect to be distributed very finely in the rinsing liquor so that the solubility and the cleaning capacity is improved.

The gas having an oxidising effect is advantageously added to the rinsing liquor for solution and reaction using a water jet pump with a diffuser for fine distribution of the gas. The use of a diffuser allows the gas having an oxidising effect to be distributed very finely in the rinsing liquor so that the solubility and the cleaning capacity is improved.

Appropriately, the surface tension of the rinsing liquor is lowered by adding tensides to the rinsing liquor and the effect of the ultrasonic nebuliser is thereby enhanced.

In an advantageous embodiment, the gas having an oxidising effect is ozone which is produced in an ozone generator. Ozone is the strongest gaseous oxidising agent so that a particularly strong cleaning and disinfectant effect is obtained therefrom and furthermore, it can be produced very simply in an ozone generator in situ in a dishwasher.

In a use according to the invention of ozone-enriched mist in a washing container of a dishwasher, at least items to be washed can be cleaned.

### BRIEF DESCRIPTION OF THE DRAWINGS

These and other features of this disclosure will be more readily understood from the following detailed description of the various aspects of the disclosure taken in conjunction with the accompanying drawing that depicts various embodiments of the disclosure, in which:

FIG. 1 is a cross-section through a washing container of a dishwasher according to the invention with an ozone generator.

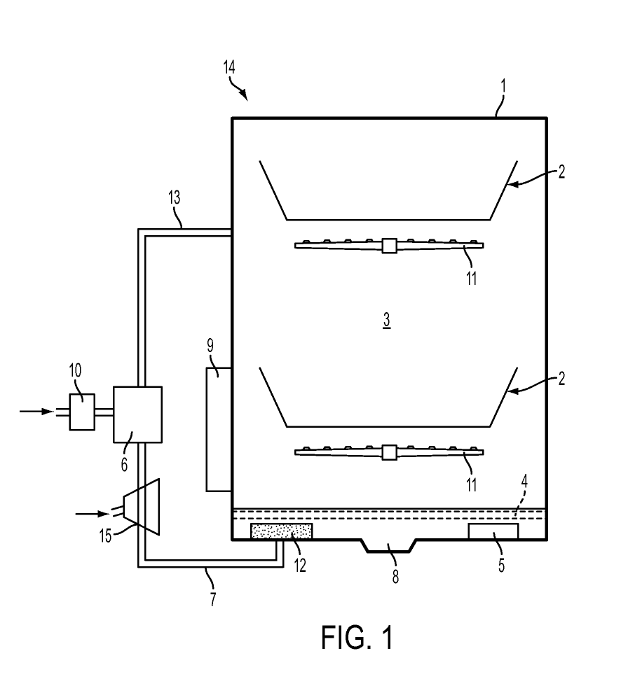

### DETAILED DESCRIPTION OF EXEMPLARY EMBODIMENTS OF THE PRESENT INVENTION

Gases having an oxidising effect, e.g. ozone and chlorine, have numerous effects. They can be used for cleaning, decolouring (bleaching), deodorising and disinfection. Ozone O₃ as active oxygen and an unstable modification of O₂ is a very efficient oxidising agent and is 1.5 times more efficient than chlorine. In contrast to using chlorine, no environmentally harmful compounds are produced. Ozone can be produced simply and cheaply using an ozone generator at the usage location in the dishwasher. A Siemens tube, for example, which produces ozone from oxygen in the air by means of a high-voltage dark electric discharge can be used as an ozone generator. Ozone is therefore preferably used as the gas having an oxidising effect in dishwashers.

The contaminants to be removed from items to the washed in dishwashers are organic compounds, especially protein and grease contaminants e.g. in the form of milk, margarine, meat or vegetable residues. These organic compounds are partly oxidised by the ozone oxidising agent (primary, direct reaction of ozone) and thereby cleaned. When ozone dissolves in water, OH radicals (hydroxyl radicals) are formed by a chemical reaction and these react with organic compounds, i.e. this involves a reaction of secondary oxidants formed during breakdown of ozone (OH′ radicals). This reaction of secondary oxidants is designated as an OH′ radical reaction. A special case of the OH radical reaction is ozone attachment to a double bond as ozonolysis.

Furthermore, a decolouring (bleaching) of organic discolorations, resulting from black tea for example, can be achieved with ozone. The organic discolorations are oxidised so that no additional, environmentally harmful and expensive bleaching agents e.g. sodium perborate monohydrate and activator TAED are required. In addition, deodorising can be achieved with ozone so that odours in the washing container typical of dishwashers can easily be removed. Ozone also has a disinfecting action. As a result, bacteria growth is severely restricted or completely suppressed which substantially improves the hygiene conditions. Advantageously, in new drying processes which remove moist air from the washing container in an air cycle and introduce dry and warm air back into the washing container again, the heating temperatures in a partial program step, e.g. “clean” or “clear rinse” are thus kept low because strong heating merely for disinfection is no longer required. This makes it possible to achieve a considerable saving of energy.

In a dishwasher 14 according to the invention comprising a washing container 1 with interior 3, crockery basket 2, sump 8 and spray arms 11, i.e. especially as rotating spray arms or as a fixed spray base, ozone is generally added with the other components of the air to the rinsing liquor 4 and/or the interior 3 of the washing container 1 during a partial program step with a cleaning action, e.g. “clean”. The partial program steps “intermediate rinse” and “clear rinse” also have a cleaning action to remove residual contamination and the partial program step “pre-wash”, to remove the coarsest contamination. As a result, the ozone can usefully perform its cleaning and disinfecting action in particular and also its decolouring and deodorising function. For this purpose, the ozone and normally the other components of the air are either introduced into the rinsing liquor 4 for reaction and/or solution or introduced into the interior 3 of the washing container 1. The ozone is introduced into the rinsing liquor 4, for example, using a porous membrane 12 (frit or sprudelstein) at the bottom of the washing container 1. For this purpose, the ozone obtained from the oxygen in the air using the ozone generator 6 is introduced into the porous membrane 12 via the feed pipe 7. An air pump 10 is additionally used for this purpose. As a result of the microscopically small pores of the membrane 12, very small air bubbles with ozone enter into the rinsing liquor 4 which increases the solubility and the reactability as a result of the larger ratio of surface area of volume of air. When air containing ozone is introduced into the interior 3 of the washing container 1, the ozone dissolves and reacts with the rinsing liquor 4 on actuating the spray arms 11.

In addition, the air containing ozone can be sucked into the rinsing liquor 4 using a water jet pump 15, where rinsing liquor 4 is understood in this context also as the raw water used as rinsing liquor 4. Following the nozzle-shaped constriction with negative pressure for sucking in air, the water jet pump 15 advantageously has a section of significantly increased cross-section as a diffuser. As a result of the fine distribution of the ozone in the water jet pump in the diffuser, the solubility of the ozone in the water is increased and the formation of OH′ radicals is made easier. The water jet pump can be contained in the raw water pipe for the rinsing liquor 4 and in the circulating pipe of the circulating pump for acting upon the spray arms 11 (not shown). In this case, preferably not all the rinsing liquor contained in the circulating pipe is fed through the water jet pump but a part thereof is fed via a branch, where a control valve is provided at the branch for example, so that the fraction which is passed through the water jet pump can be regulated. Thus, the quantity of ozone introduced into the rinsing liquor can be regulated (not shown).

Another advantage of ozonating the rinsing liquor 4 is that the rinsing liquor 4 can be better stored in an intermediate rinsing liquor reservoir (not shown). A rinsing-liquor reservoir is used for intermediate storage of at least some of the rinsing liquor 4 which is no longer required after implementing a partial program step e.g. “clear rinse” and which is normally pumped away by the lye pump (not shown), for re-use in a following part process step, e.g. “pre-wash”. A problem here is that vigorous growth of bacteria and fungi occurs during fairly long storage times in the rinsing liquid reservoir and as a result, re-using the rinsing liquor in the reservoir presents problems for hygiene reasons or is impossible. Rinsing liquor disinfected with ozone prevents vigorous growth of bacteria and fungi in the rinsing liquid reservoir and thus advantageously allows the rinsing liquor to be stored in a rinsing liquor reservoir and re-used without any problems.

In an additional embodiment, the dishwasher according to the invention 14 has a heat exchanger 9 at a wall of the washing container 1. The heat exchanger 9 can be filled with raw water so that a cold condensation surface is formed at the wall of the washing container 1 during the partial program step “dry” in order to enhance the drying performance. Preferably, the raw water in the heat exchanger 9 is also enriched with ozone especially before filling with a water jet pump or by a porous membrane in the heat exchanger 9. As a result of the disinfecting action of ozone in the heat exchanger 9, the growth of bacteria and fungi is thereby avoided so that the water from the heat exchanger 9 can be used as rinsing liquor without any problems. In addition, as a result of the ozone enrichment of this water, all the effects of ozone are obtained when this water is used as rinsing liquor 4.

In a particularly advantageous embodiment of the invention, mist, i.e. small droplets in the air, can be produced in the interior 3 of the washing container 1 using a nebulising device e.g. an ultrasound nebuliser 5 or a nebulising nozzle. For this purpose, an ultrasonic nebuliser 5 is preferably arranged at the bottom of the washing container 1, for example. The ultrasonic nebuliser 5 nebulises some of the rinsing liquor 4, and the mist is distributed in the washing container 1. The ozone is either introduced into the rinsing liquor 4 by enriching the rinsing liquor 4 in the washing container 1, as described above, with ozone and also with hydroxyl radicals resulting therefrom or ozone-containing air is fed directly into the washing container 1 via the feed pipe 13 using the ozone generator 6. The ozone generator preferably removes air from the washing container 1 so that no excess pressure is produced (not shown) in the washing container 1. In the last-mentioned case, ozone attaches to the fine droplets, dissolves in the droplets and hydroxyl radicals are formed. For better distribution of the mist in the washing container 1, the circulating pump (not shown) is activated and the spray arms 11 move as a result, causing an air flow and turbulence in the washing container 1 for better distribution.

In an additional advantageous embodiment, the spray arms 11 can be moved by a motor, e.g. using an electric motor without the circulating pump being switched on and in the washing container 1 the rinsing liquor 4 is distributed by means of nozzles to the spray arms 11. A better distribution of the mist in the interior 3 of the washing container 1 can thus be achieved with the spray arms 11 without some of the mist being taken up again by the rinsing liquor 4 distributed by means of the spray arms 11. In this case, the spray arms 11 can largely be designed to achieve this optimised ventilator effect.

The contaminants on the items to be washed (not shown) e.g. dried-on contaminants, have pores with a diameter of generally around 6 μm. The mist droplets in the washing container 1 generally have a diameter of 3 μm. As a result, the mist droplets can penetrate into the fine pores of the contaminants of the items to be washed and in addition to the effect on the surface, advantageously and effectively act inside the contaminants. This makes it possible to achieve partial oxidation inside the contaminants by the ozone in the mist droplets and a reaction of the hydroxyl radicals with the contaminants, e.g. as ozonolysis. The cleaning performance using ozone is thereby substantially improved, particularly in the case of dried-on contaminants which so far have only been removed with difficulty.

The ozone concentration in the rinsing liquor decreases as a result of outgassing, reaction with organic compounds or decay of the ozone to form secondary oxidants. The half-life of water gassed with ozone lies between one and twenty minutes. The reactions of the ozone in the rinsing liquor are pH-dependent. The ozone is more stable in an acid environment. Consequently, the half-life of ozone can be increased and thus its cleaning and disinfecting action as well as its decolouring and deodorising function can be improved by adding clear rinsing agents, which contain citric acid, for example. Consequently, clear rinsing agents are preferably added in the partial program step “clear rinse”, for example during ozonization in order to improve the effects of the ozone (not shown).

The addition of tensides contained in clear rinsing agents and detergents lowers the surface tension of the rinsing liquor and thus improves the action of the ultrasonic nebuliser. The larger quantity of mist in the washing container 1 thus increases the effects of the ozone. For this reason tensides are preferably added with mist during the ozonization (not shown).

The dishwasher according to the invention allows all the effects of ozone to be used, especially its cleaning and disinfecting action as well as its decolouring and deodorising function because the ozone is added in partial program steps which can utilise all the effects of ozone. The ozone acts particularly advantageously on the contamination of crockery via mist droplets so that the effects of the ozone take place not only on the surface of the contaminants but also via the pores inside the contaminants because the diameter of the mist droplets is smaller than the diameter of the contaminant pores. In particular, in the case of dried-on contaminants which could only be removed with difficulty hitherto, a considerable increase in the degree of cleaning can be achieved.

1. A dishwasher, comprising:
a washing container;
devices for applying rinsing liquor to items to be washed in the washing container; and
one or more devices for generating a gas having an oxidizing effect and providing the gas having the oxidizing effect to the washing container during at least one of a pre-wash, clean, intermediate rinse, and clear rinse partial program of a wash program, wherein the gas having the oxidizing effect is employed together with the rinsing liquor and applied to the items to be washed.

2. The dishwasher according to claim 1, wherein the gas having the oxidizing effect is provided to the washing container by at least one of adding the gas to the rinsing liquor, adding the gas to raw water, and adding the gas into an interior of the washing container.

3. The dishwasher according to claim 1, wherein the gas having the oxidizing effect employed together with the rinsing liquor effects cleaning, disinfecting, decolouring, and deodorizing of the items to be washed in the washing container.

4. The dishwasher according to claim 1, wherein the one or more devices for generating a gas having an oxidizing effect comprises an ozone generator.

5. The dishwasher according to claim 2, wherein the gas having an oxidizing effect is applied to the items to be washed in cooperation with mist in the interior of the washing container.

6. The dishwasher according to claim 5, wherein the mist is produced from the rinsing liquid or the raw water by a nebulizing device the nebulizing device including at least one of an ultrasound nebulizer and a nebulizing nozzle.

7. The dishwasher according to claim 6, wherein the gas having an oxidizing effect is added to the rinsing liquor or the raw water, which is supplied to the nebulizing device, prior to use in the at least one of the pre-wash, clean, intermediate rinse, and clear rinse partial program of the wash program.

8. The dishwasher according to claim 6, wherein the rinsing liquor or the raw water is supplied to the nebulizing device and the gas having an oxidizing effect is added directly to the interior of the washing container.

9. The dishwasher according to claim 2, wherein the gas having an oxidizing effect is added to the rinsing liquor, using a porous membrane in the rinsing liquor positioned at the bottom of the washing container.

10. The dishwasher according to claim 2, wherein the gas having an oxidizing effect is added to the rinsing liquor using a water jet diffuser for fine distribution of the gas.

11. The dishwasher according to claim 2, wherein a water jet pump is disposed in at least one of a raw water pipe and in a circulating pipe for acting upon the devices for applying rinsing liquor to the items to be washed, wherein only a portion of the raw water or the rinsing liquor is passed to the water jet pump via a branch connecting the at least one of the raw water pipe and the circulating pipe with the water jet pump.

12. The dishwasher according to claim 11, wherein a control valve is provided at the branch.

13. The dishwasher according to claim 2, wherein the gas having an oxidizing effect is added to the rinsing liquor or the raw water in at least one of a rinsing liquor reservoir and a heat exchanger.

14. The dishwasher according to claim 1, wherein the gas having an oxidizing effect comprises ozone.

15. A method for using a gas having an oxidizing effect in a dishwasher, comprising:
providing a dishwasher, comprising:
a washing container;
devices for applying rinsing liquor to items to be washed in the washing container; and
one or more devices for generating a gas having an oxidizing effect and providing the gas having the oxidizing effect to the washing container during at least one of a pre-wash, clean, intermediate rinse, and clear rinse partial program of a wash program, wherein the gas having the oxidizing effect is employed together with the rinsing liquor and applied to the items to be washed;
adding the gas having the oxidizing effect to the rinsing liquor or raw water and/or into an interior of the washing container for use in at least one of the pre-wash, clean, intermediate rinse, and clear rinse partial program of the wash program; and
treating the items to be washed with the gas having the oxidizing effect together with the rinsing liquor.

16. The method according to claim 15, wherein the gas having the oxidizing effect employed together with the rinsing liquor effects cleaning, disinfecting, decolouring, and deodorizing of the items to be washed in the washing container.

17. The method according to claim 15, wherein the one or more devices for generating a gas having an oxidizing effect comprises an ozone generator.

18. The method according to claim 15, wherein the gas having an oxidizing effect is applied to the items to be washed in cooperation with mist in the interior of the washing container.

19. The method according to claim 18, wherein the mist is produced from the rinsing liquid or the raw water by a nebulizing device the nebulizing device including at least one of an ultrasound nebulizer and a nebulizing nozzle.

20. The method according to claim 19, wherein the gas having an oxidizing effect is added to the rinsing liquor or the raw water, which is supplied to the nebulizing device, prior to use in the at least one of the pre-wash, clean, intermediate rinse, and clear rinse partial program of the wash program.

21. The method according to claim 19, wherein the rinsing liquor or the raw water is supplied to the nebulizing device and the gas having an oxidizing effect is added directly to the interior of the washing container.

22. The method according to claim 15, wherein the gas having an oxidizing effect is added to the rinsing liquor, using a porous membrane in the rinsing liquor positioned at the bottom of the washing container.

23. The method according to claim 15, wherein the gas having an oxidizing effect is added to the rinsing liquor using a water jet diffuser for fine distribution of the gas.

24. The method according to claim 15, wherein a water jet pump is disposed in at least one of a raw water pipe and in a circulating pipe for acting upon the devices for applying rinsing liquor to the items to be washed, wherein only a portion of the raw water or the rinsing liquor is passed to the water jet pump via a branch connecting the at least one of the raw water pipe and the circulating pipe with the water jet pump.

25. The method according to claim 24, wherein a control valve is provided at the branch.

26. The method according to claim 15, further comprising adding a rinsing agent.

27. The method according to claim 26, wherein the rinsing agent comprises a quantity of at least one of tensides and citric acid.

28. The method according to claim 15, wherein the gas having an oxidizing effect is ozone.

29. The method according to claim 15, wherein the gas having an oxidizing effect is added to the rinsing liquor or the raw water in at least one of a rinsing liquor reservoir and a heat exchanger.

30. A dishwasher comprising a washing container and devices for applying rinsing liquor to items to be washed in the washing container, the washing container being operable to receive therein ozone-enriched mist at least during one of a pre-wash, clean, intermediate rinse, and clear rinse partial program of a wash program the ozone-enriched mist to be used in cooperation with the rinse liquor for cleaning items to be washed.
